(19) United States
(12) Patent Application Publication
(10) Pub. No.: US 2006/0068197 A1
(43) Pub. Date: Mar. 30, 2006

(54) Water-dispersing plastic bodies and method for the production thereof

(76) Inventors: Thomas Hasskerl, Kronberg (DE); Rolf Neeb, Pfungstadt (DE); Ghirmay Seyoum, Egelsbach (DE); Patrick Becker, Muehltal (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/538,887

(22) PCT Filed: Oct. 18, 2003
(86) PCT No.: PCT/EP03/11536

§ 371 Date: Jun. 14, 2005

(30) Foreign Application Priority Data
Dec. 17, 2002 (DE) 10259238.1

(51) Int. Cl. B32B 27/36; B32B 27/30; B32B 27/32; B32B 9/04

(52) U.S. Cl. 428/332; 428/411.1; 428/523; 428/480; 428/412; 428/522; 428/337; 156/307.3

(57) ABSTRACT

The invention relates to water-dispersing plastic bodies made of a plastic substrate, at least one water-dispersing, inorganic coating (a) and an adhesive promoting intermediate layer (b) which is arranged between the plastic substrate and the inorganic coating. The invention is characterised in that the intermediate layer comprises two polymers (A) and (B), whereby water on one layer of the polymer (A) forms and edge angle which is smaller than or equal to 73° at 20° C. and water on one layer of the polymer (B) forms an edge angle greater than or equal to 75° at 20° C.

The present invention relates to plastics articles which inhibit water droplet formation and which comprise a plastics substrate, an inorganic coating which inhibits water droplet formation and an adhesion-promoting intermediate layer located between the plastics substrate and the inorganic coating.

Water present on the surface of plastics which inhibit water droplet formation does not coalesce to give separate droplets: instead, the droplets spread and, on contact, flow together to give a coherent layer. The result is improved light reflection at the water-moistened surface and—in the case of transparent plastics—better transmittance, and less likelihood that water droplets will fall from the underside of the plastics article.

Numerous attempts have been made to produce antifogging coatings composed of crosslinked hydrophilic polymers on water-repellent plastics surfaces.

According to DE-A 21 61 645, a coating of this type is produced from a copolymer composed of alkyl esters, hydroxyalkyl esters, and quaternary aminoalkyl esters of acrylic or methacrylic acid, and methylol ethers of methacrylamide, as crosslinking agent. They initially absorb water, with swelling, whereupon they gradually convert into a form which inhibits water droplet formation. However, the swelling makes the coating soft and perceptible to mechanical damage.

EP-A-0 149 182 also discloses articles which inhibit water droplet formation. These plastics articles comprise an inorganic coating based on SiO₂.

However, a disadvantage of the plastics articles which are disclosed in EP-A-0 149 182 and which inhibit water droplet formation is that this plastics article completely loses its property of inhibiting water droplet formation when it is thermoformed, whereupon the coating on the formed article becomes cloudy and unattractive.

In the light of the prior art discussed and presented herein, it was therefore an object of the present invention to provide plastics articles which inhibit water droplet formation and which can be thermoformed without any resultant adverse effect on the property of inhibiting water droplet formation, and without any occurrence of cloudiness.

Another object of the present invention was therefore to provide plastics articles which inhibit water droplet formation and whose coating that inhibits water droplet formation has particularly high adhesion to the plastics substrates. This property should not be impaired by moisture.

Another object of the invention was that the plastics articles are to have high durability, in particular high resistance to UV radiation or weathering.

Another object on which the invention was based was to provide plastics articles which inhibit water droplet formation and which can be produced in a particularly simple manner. For example, the substrates which can be used to produce the plastics articles should in particular be those obtainable by extrusion or injection moulding, or else by casting processes.

Another object of the present invention consisted in indicating plastics articles which inhibit water droplet formation and have excellent mechanical properties. This property is particularly important for applications in which the plastics article is intended to have high resistance to impact.

In addition, the plastics articles should have particularly good optical properties.

Another object of the present invention consisted in providing plastics articles whose size and shape can easily be adapted to the requirements.

The plastics articles described in claim 1 achieve these objects, and also achieve other objects which, although they are not specifically mentioned, are obvious or necessary consequences of the circumstances discussed herein. Useful modifications of the plastics articles of the invention are protected by the subclaims dependent on claim 1.

Claim 24 achieves the underlying object with regard to production processes.

Plastics articles which inhibit water droplet formation, and which can be thermoformed without any resultant adverse effect on the property of inhibiting water droplet formation, and without any occurrence of cloudiness, can be obtained if the adhesion-promoting intermediate layer (b) located between a plastics substrate and an inorganic coating (a) which inhibits water droplet formation encompasses two polymers (A) and (B), where water forms a contact angle smaller than or equal to 73° on a layer of the polymer (A) at 20° C., and water forms a contact angle greater than or equal to 75° on a layer of the polymer (B) at 20° C.

Particular advantages achieved by the inventive measures are, inter alia, the following:
The coatings which inhibit water droplet formation on the plastics articles according to the invention have particularly high adhesion to the plastics substrates, this property also remaining unimpaired on exposure to moisture.
The plastics articles of the invention exhibit high resistance to UV radiation.
The plastics articles of the invention can be produced at low cost.
The plastics articles of the present invention can be adapted to particular requirements. In particular, the size and the shape of the plastics article may be varied within a wide range without any resultant impairment of formability. Furthermore, the present invention also provides plastics articles with excellent optical properties.
The plastics articles of the present invention have good mechanical properties.

The plastics articles of the invention are obtainable by coating plastics substrates. Plastics substrate suitable for the purposes of the present invention are known per se. These substrates encompass in particular polycarbonates, polystyrenes, polyesters, such as polyethylene terephthalate (PET), which may also have been glycol-modified, and polybutylene terephthalate (PBT), cycloolefinic polymers (COCs) and/or poly(meth)acrylates. Preference is given here to polycarbonates, cycloolefinic polymers and poly-(meth)acrylates, particular preference being given to poly(meth)acrylates.

Polycarbonates are known to persons skilled in the art. Polycarbonates may be formally regarded as polyesters composed of carbonic acid and of aliphatic or aromatic dihydroxy compounds. They are easily obtainable by reacting diglycols or bisphenols with phosgene or carbonic diesters in polycondensation or transesterification reactions.

Preference is given here to polycarbonates which derive from bisphenols. Particular bisphenols among these are 2,2-bis(4-hydroxyphenyl)propane (bisphenol A), 2,2-bis(4-hydroxyphenyl)butane (bisphenol B), 1,1-bis(4-hydroxyphenyl)cyclohexane (bisphenol C), 2,2′-methylenediphenol (bisphenol F), 2,2-bis(3,5-dibromo-4-hydroxyphenyl)propane (tetrabromobisphenol A) and 2,2-bis(3,5-dimethyl-4-hydroxyphenyl)propane (tetramethyl-bisphenol A).

These aromatic polycarbonates are usually prepared by interfacial polycondensation or by transesterification, details being given in Encycl. Polym. Sci. Engng. 11, 648-718.

In interfacial polycondensation, the bisphenols in the form of aqueous alkaline solution are emulsified in inert organic solvents, such as methylene chloride, chlorobenzene or tetrahydrofuran, and reacted with phosgene in a reaction involving stages. Amines are used as catalysts, and phase-transfer catalysts are used in the case of sterically hindered bisphenols. The resultant polymers are soluble in the organic solvents used.

The properties of the polymers may be varied widely via the selection of the bisphenols. If different bisphenols are used together, block polymers can also be constructed in multistage polycondensations.

Cycloolefinic polymers are polymers obtainable by using cyclic olefins, in particular by using polycyclic olefins.

Cyclic olefins encompass, for example, monocyclic olefins, such as cyclopentene, cyclopentadiene, cyclohexene, cycloheptene, cyclooctene, and also alkyl derivatives of these monocyclic olefins having from 1 to 3 carbon atoms, examples being methyl, ethyl or propyl, e.g. methylcyclohexene or dimethylcyclohexene, and also acrylate and/or methacrylate derivatives of these monocyclic compounds. Furthermore, cycloalkanes having olefinic side chains may also be used as cyclic olefins, an example being cyclopentyl methacrylate.

Preference is given to bridged polycyclic olefin compounds. These polycyclic olefin compounds may have the double bond either in the ring, in which case they are bridged polycyclic cycloalkenes, or else in side chains. In that case they are vinyl derivatives, allyloxycarboxy derivatives or (meth)acryloxy derivatives of polycyclic cycloalkane compounds. These compounds may also have alkyl, aryl or aralkyl substituents.

Without any intended resultant restriction, examples of polycyclic compounds are bicyclo[2.2.1]hept-2-ene (norbornene), bicyclo[2.2.1]hept-2,5-diene (2,5-norbornadiene), ethylbicyclo[2.2.1]hept-2-ene (ethylnorbornene), ethylidenebicyclo[2.2.1]hept-2-ene (ethylidene-2-norbornene), phenylbicyclo[2.2.1]hept-2-ene, bicyclo[4.3.0]nona-3,8-diene, tricyclo[4.3.0.1^{2,5}]-3-decene, tricyclo[4.3.0.1^{2,5}]-3,8-decene-(3,8-dihydrodicyclopentadiene), tricyclo[4.4.0.1^{2,5}]-3-undecene, tetracyclo[4.4.0.1^{2,5},1^{7,10}]-3-dodecene, ethylidenetetracyclo[4.4.0.1^{2,5}.1^{7,10}]-3-dodecene, methyloxycarbonyltetracyclo[4.4.0.1^{2,5},1^{7,10}]-3-dodecene, ethylidene-9-ethyltetracyclo[4.4.0.1^{2,5},1^{7,10}]-3-dodecene, pentacyclo[4.7.0.1^{2,5},O,O^{3,13},1^{9,12}]-3-pentadecene, pentacyclo[6.1.1^{3,6}.1^{10,13}.0^{2,7}.0^{9,13}]-4-pentadecene, hexacyclo[6.6.1.1^{3,6}.1^{10,13}.0^{2,7}.0^{9,14}]-4-heptadecene, dimethylhexacyclo[6.6.1.1^{3,6}.1^{10,13}.0^{2,7}.0^{9,14}]-4-heptadecene, bis(allyloxycarboxy)tricyclo[4.3.0.1^{2,5}]decane, bis(methacryloxy)tricyclo[4.3.0.1^{2,5}]decane, bis(acryloxy)tricyclo[4.3.0.1^{2,5}]decane.

The cycloolefinic polymers are prepared using at least one of the cycloolefinic compounds described above, in particular the polycyclic hydrocarbon compounds. The preparation of the cycloolefinic polymers may, furthermore, use other olefins which can be copolymerized with the abovementioned cycloolefinic monomers. Examples of these are ethylene, propylene, isoprene, butadiene, methylpentene, styrene, and vinyltoluene.

Most of the abovementioned olefins, and in particular the cycloolefins and polycycloolefins, may be obtained commercially. Many cyclic and polycyclic olefins are moreover obtainable by Diels-Alder addition reactions. The cycloolefinic polymers may be prepared in a known manner, as set out inter alia in the Japanese Patent Specifications 11818/1972, 43412/1983, 1442/1986 and 19761/1987 and in the published Japanese Patent Applications Nos. 75700/1975, 129434/1980, 127728/1983, 168708/1985, 271308/1986, 221118/1988 and 180976/1990 and in the European Patent Applications EP-A-0 6 610 851, EP-A-0 6 485 893, EP-A-0 6 407 870 and EP-A-0 6 688 801.

The cycloolefinic polymers may, for example, be polymerized in a solvent, using aluminium compounds, vanadium compounds, tungsten compounds or boron compounds as catalyst.

It is assumed that, depending on the conditions, in particular on the catalyst used, the polymerization can proceed with ring-opening or with opening of the double bond.

It is also possible to obtain cycloolefinic polymers by free-radical polymerization, using light or an initiator as free-radical generator. This applies in particular to the acryloyl derivatives of the cycloolefins and/or cycloalkanes. This type of polymerization may take place either in solution or else in bulk.

Another preferred plastics substrate encompasses poly(meth)acrylates. These polymers are generally obtained by free-radical polymerization of mixtures which comprise (meth)acrylates. The term (meth)acrylates encompasses methacrylates and acrylates, and also mixtures of the two.

These monomers are well known. Among them are, inter alia, (meth)acrylates derived from saturated alcohols, e.g. methyl (meth)acrylate, ethyl (meth)acrylate, propyl (meth)acrylate, n-butyl (meth)acrylate, tert-butyl (meth)acrylate, pentyl (meth)acrylate and 2-ethylhexyl (meth)acrylate; (meth)acrylates derived from unsaturated alcohols, e.g. oleyl (meth)acrylate, 2-propynyl (meth)acrylate, allyl (meth)acrylate, vinyl (meth)acrylate; aryl (meth)acrylates, such as benzyl (meth)acrylate or phenyl (meth)acrylate, where each of the aryl radicals may be unsubstituted or have up to four substituents;
cycloalkyl (meth)acrylates, such as 3-vinylcyclohexyl (meth)acrylate, bornyl (meth)acrylate; hydroxyalkyl (meth)acrylates, such as 3-hydroxypropyl (meth)acrylate, 3,4-dihydroxybutyl (meth)acrylate, 2-hydroxyethyl (meth)acrylate, 2-hydroxypropyl (meth)acrylate;
glycol di(meth)acrylates, such as 1,4-butanediol di(meth)acrylate, (meth)acrylates of ether alcohols, such as tetrahydrofurfuryl (meth)acrylate, vinyloxyethoxyethyl (meth)acrylate;
amides and nitriles of (meth)acrylic acid, e.g. N-(3-dimethylaminopropyl)(meth)acrylamide, N-(diethylphosphono)(meth)acrylamide, 1-methacryloylamido-2-methyl-2-propanol;
sulphur-containing methacrylates, such as ethylsulphinylethyl (meth)acrylate, 4-thiocyanatobutyl (meth)acrylate, ethylsulphonylethyl (meth)acrylate, thiocyanatomethyl (meth)acrylate, methylsulphinylmethyl (meth)acrylate, bis((meth)acryloyloxyethyl) sulphide;
multifunctional (meth)acrylates, such as trimethyloylpropane tri(meth)acrylate, pentaerythritol tetra(meth)acrylate and pentaerythritol tri(meth)acrylate.

In one preferred aspect of the present invention, these mixtures comprise at least 40% by weight, preferably at least 60% by weight, and particularly preferably at least 80% by weight, of methyl methacrylate, based on the weight of monomers.

Besides the (meth)acrylates set out above, the compositions to be polymerized may also comprise other unsaturated monomers which are copolymerizable with methyl methacrylate and with the abovementioned (meth)acrylates.

Examples of these are 1-alkenes, such as 1-hexene, 1-heptene; branched alkenes, such as vinylcyclohexane, 3,3-dimethyl-1-propene, 3-methyl-1-diisobutylene, 4-methyl-1-pentene;

acrylonitrile; vinyl esters, such as vinyl acetate; styrene, substituted styrenes having one alkyl substituent in the side chain, e.g. α-methylstyrene and α-ethylstyrene, substituted styrenes having one alkyl substituent on the ring, e.g. vinyltoluene and p-methylstyrene, halogenated styrenes, such as monochlorostyrenes, dichlorostyrenes, tribromostyrenes, and tetrabromostyrenes;

heterocyclic vinyl compounds, such as 2-vinylpyridine, 3-vinylpyridine, 2-methyl-5-vinylpyridine, 3-ethyl-4-vinylpyridine, 2,3-dimethyl-5-vinylpyridine, vinylpyrimidine, vinylpiperidine, 9-vinylcarbazole, 3-vinylcarbazole, 4-vinylcarbazole, 1-vinylimidazole, 2-methyl-1-vinylimidazole, N-vinylpyrrolidone, 2-vinylpyrrolidone, N-vinylpyrrolidine, 3-vinyl-pyrrolidine, N-vinylcaprolactam, N-vinylbutyrolactam, vinyloxolane, vinylfuran, vinylthiophene, vinylthiolane, vinylthiazoles, and hydrogenated vinylthiazoles, vinyloxazoles and hydrogenated vinyloxazoles;

vinyl and isoprenyl ethers;

maleic acid derivatives, such as maleic anhydride, methylmaleic anhydride, maleimide, methylmaleimide; and dienes, such as divinylbenzene.

The amount generally used of these comonomers is from 0 to 60% by weight, preferably from 0 to 40% by weight, and particularly preferably from 0 to 20% by weight, based on the weight of the monomers, and the compounds here may be used individually or as a mixture.

The polymerization is generally initiated by known free-radical initiators. Examples of preferred initiators are the azo initiators well known to persons skilled in the art, e.g. AIBN and 1,1-azobiscyclo-hexanecarbonitrile, and also peroxy compounds, such as methyl ethyl ketone peroxide, acetylacetone peroxide, dilauryl peroxide, tert-butyl per-2-ethylhexanoate, ketone peroxide, methyl isobutyl ketone peroxide, cyclohexanone peroxide, dibenzoyl peroxide, tert-butyl peroxybenzoate, tert-butylperoxy isopropyl carbonate, 2,5-bis(2-ethylhexanoylperoxy)-2,5-dimethylhexane, tert-butylperoxy 2-ethylhexanoate, tert-butylperoxy 3,5,5-trimethylhexanoate, dicumyl peroxide, 1,1-bis(tert-butylperoxy)cyclohexane, 1,1-bis(tert-butylperoxy)-3,3,5-trimethylcyclohexane, cumyl hydroperoxide, tert-butyl hydroperoxide, bis(4-tert-butylcyclohexyl) peroxydicarbonate, mixtures of two or more of the abovementioned compounds with one another, and also mixtures of the abovementioned compounds with compounds not mentioned which can likewise form free radicals.

The amount often used of these compounds is from 0.01 to 3% by weight, preferably from 0.05 to 1% by weight, based on the weight of the monomers.

The abovementioned polymers may be used individually or as a mixture. Use may also be made here of various polycarbonates, poly(meth)acrylates or cycloolefinic polymers which differ, for example, in molecular weight or in monomer composition.

The plastics substrates of the invention may, for example, be produced from moulding compositions of the abovementioned polymers. For this, use is generally made of thermoplastic shaping processes, such as extrusion or injection moulding.

The weight-average molar mass M_{w} of the homo- and/or copolymers to be used according to the invention as moulding compositions for producing the plastics substrates may vary within a wide range, the molar mass usually being matched to the application and the method used for processing the moulding composition. However, with no intended resultant restriction, it is generally in the range from 20 000 to 1 000 000 g/mol, preferably from 50 000 to 500 000 g/mol, and particularly preferably from 80 000 to 300 000 g/mol. An example of a method for determining this variable is gel permeation chromatography.

The plastics substrates may also be produced by cell casting processes. In these, by way of example, suitable (meth)acrylic mixtures are charged to a mould and polymerized. These (meth)acrylic mixtures generally comprise the (meth)acrylates set out above, in particular methyl methacrylate. The (meth)acrylic mixtures may moreover comprise the copolymers set out above, and also, in particular for viscosity adjustment, may comprise polymers, in particular poly(meth)acrylates.

The weight-average molar mass M_{w} of the polymers prepared by cell casting processes is generally higher than the molar mass of polymers used in moulding compositions. This gives a number of known advantages. With no resultant intended restriction, the weight-average molar mass of polymers prepared by cell casting processes is generally in the range from 500 000 to 10 000 000 g/mol.

Preferred plastics substrates prepared by the cell casting process may be obtained commercially with the trade name ®Plexiglas GS from Röhm GmbH & Co. KG.

The moulding compositions used to produce the plastics substrates, and also the acrylic resins, may also comprise conventional additives of any type. Examples of these are antistatic agents, antioxidants, mould-release agents, flame retardants, lubricants, dyes, flow improvers, fillers, light stabilizers and organophosphorus compounds, such as phosphites, phosphorinanes, phospholanes or phosphonates, pigments, weathering stabilizers and plasticizers. However, the amount of additives is restricted in relation to the application.

Particularly preferred moulding compositions which encompass poly(meth)acrylates are obtainable with the trade name PLEXIGLAS® from the company Degussa AG. Preferred moulding compositions which encompass cycloolefinic polymers may be purchased with the trade name ®Topas from Ticona and ®Zeonex from Nippon Zeon. Polycarbonate moulding compositions are obtainable, by way of example, with the trade name ®Makrolon from Bayer or ®Lexan from General Electric.

The plastics substrate particularly preferably encompasses at least 80% by weight, in particular at least 90% by weight, based on the total weight of the substrate, of poly(meth)acrylates, polycarbonates and/or cycloolefinic polymers. The plastics substrates are particularly preferably composed of polymethyl methacrylate, and this polymethyl methacrylate may comprise conventional additives.

In one preferred embodiment, plastics substrates may have an impact strength to ISO 179/1 of at least 10 kJ/m², preferably at least 15 kJ/m².

The shape, and also the size, of the plastics substrate are not important for the present invention. Substrates generally used often have the shape of a sheet or a panel, and have a thickness in the range from 1 mm to 200 mm, in particular from 5 to 30 mm.

Before the plastics substrates are provided with a coating, they may be activated by suitable methods in order to improve adhesion. For this, by way of example, the plastics substrate may be treated by a chemical and/or physical process, the particular process here being dependent on the plastics substrate.

The plastics articles of the present invention are initially provided with an adhesion-promoting intermediate layer (b) located between the plastics substrate and the inorganic coating which encompasses two polymers (A) and (B), where water forms a contact angle smaller than or equal to 73° on a layer of the polymer (A) at 20° C., and water forms a contact angle greater than or equal to 75° on a layer of the polymer (B). The contact angle is determined at 20° C., using a G40 contact angle measurement system from Krüss, Hamburg.

The layer thickness for determining the contact angle here is not significant, but the water is in contact only with a layer composed of the polymer (A) or, respectively, of the polymer (B). A layer thickness of 50 μm or less is generally sufficient. However, the layer should be smooth to permit correct determination of the contact angle. The values are applicable to a surface which is substantially smooth. The production of a surface of this type is known to the person skilled in the art. Given a sufficient layer thickness, a smooth surface forms spontaneously when a flow-coating process is used.

The important property of the adhesion-promoting layer is that its adhesion, both to the plastics surface and to the layer which inhibits water droplet formation, is greater than that of the latter to the plastics surface. While there are numerous organic polymer materials which adhere well to a water-repellent plastics surface, adequate adhesion to the layer which inhibits water droplet formation requires particular properties.

These properties are based on polymers (A) having polar groups and located in the adhesion-promoting layer, these polymers having low solubility and low swellability in water. The polarity of the polymers (A) is apparent by way of a low contact angle formed by water on a layer formed from polymers (A). This layer may comprise negligibly small amounts of additives or solvent residues, and it is essential here that these additives do not affect the contact angle. A layer of the polymer (A) therefore forms a contact angle smaller than or equal to 73° at 20° C., and the contact angle of the polymers (A) is preferably in the range from 50° to 72°, and particularly preferably in the range from 65° to 71°.

The nature of the polymer (A) is not subject to any particular restriction, as long as the polarity is present, this being reflected in the contact angle formed by water on a surface composed of polymer (A).

This polarity may generally be achieved via polar groups which may be a constituent of the main chain and/or of side chains.

The polymer (A) may therefore be obtained by polyaddition or polycondensation reactions. Examples here are polyethers, polyesters, polycarbonates, polyurethanes, epoxy resins and polyamides.

Polyvinyl compounds are another group of compounds suitable as polymer. Examples of these are polyolefins, such as polypropylene, polyethylene; polyaryl compounds, such as polystyrene; poly(meth)acrylates and polyvinyl acetates. Vinyl compounds suitable for preparing these polymers have been set out above.

In order that these polymers (A) have the contact angle set out above, these polymers may encompass polar groups. These groups may be incorporated into the polymer (A), by way of example, via the selection of suitable copolymers. These groups may moreover also be grafted onto a polymer by graft copolymerization.

Particular polar groups which may be mentioned are hydroxy, carboxy, sulphonyl, carboxamide, nitrile and silanol groups. They are preferably a constituent of a macromolecular compound which also contains non-polar groups, such as alkyl, alkylene, aryl or arylene groups.

The ratio of polar to non-polar groups in the polymers (A) has to be selected so as to achieve adhesion both to the water-repellent, i.e. non-polar, plastics surface, and also to the layer which inhibits water droplet formation, i.e. which is hydrophilic. The level of polarity must not be so high that the material of the adhesion-promoting layer itself is made water-soluble or water-swellable. The degree of swelling on saturation with water at 20° is not more than 10% by volume and preferably not more than 2% by volume. However, the level of polarity of the polymers (A) is also intended not to be so low that the material would be soluble in completely non-polar solvents, such as naphtha. Most of the suitable materials are soluble in organic solvents of modest polarity, such as chlorinated hydrocarbons, esters, ketones, alcohols or ethers, or mixtures of these with aromatics.

The required balance of affinities with the two adjacent layers is generally achieved if the material of the adhesion-promoting layer contains from 0.4 to 100 milliequivalents of polar groups in 100 g of the polymer material.

Polar groups differ in their polarizing action. This increases in the sequence nitrile, hydroxy, prim. carboxamide, carboxy, sulphonyl, silanol. The stronger the polarizing action, the lower the content required in the polymer material. Whereas from 4 to 100 milliequivalents of polar groups in 100 g of polymer material are used in the case of the low-polarity groups, from 0.4 to 20 milliequivalents/100 g of the high-polarity groups is sufficient. If the selected content of polar groups is too low, the layer which inhibits water droplet formation does not have sufficient adhesion. In contrast, if the content of polar groups is too high, the water-swellability increases excessively, and this in turn reduces adhesion.

The polarity of the polymers obtained by polycondensation or polyaddition, and encompassing hydroxy groups, may be increased, inter alia, by reaction with silanes which, per silicon atom, have at least two hydrolysable groups, such as halogen atom, alkoxy groups and/or aryloxy groups.

Examples of these compounds are tetraalkoxysilanes, such as tetramethoxysilane, tetraethoxysilane; trialkoxysilanes, such as methyltrimethoxysilane, methyltriethoxysilane, ethyltrimethoxysilane, n-propyl-trimethoxysilane, n-propyltriethoxysilane, isopropyl-triethoxysilane; dialkoxysilanes, such as dimethyldime-thoxysilane, dimethyldiethoxysilane, diethyldimethyoxy-silane, diethyldiethoxysilane, di-n-propyldimethoxy-silane, di-n-propyldiethoxysilane, diisopropyldimeth-oxysilane, diisopropyldiethoxysilane.

The polymers which can be obtained by free-radical polymerization of vinyl compounds may also be modified, like the polymers which can be obtained by polycondensation or polyaddition.

To modify these polyvinyl compounds, use may in particular be made of silanes which encompass vinyl groups which are not hydrolysable. Examples of the particularly suitable vinylic silane compounds are CH₂═CH—Si(OCH₃)₃, CH₂═CH—Si(OC₂H₅)₃, CH₂═CH—SiCl₃, CH₂═CH—Si(CH₃) (OCH₃)₂, CH₂═CH—CO₂—C₃H₇—Si(OCH₃)₃, CH₂═CH—CO₂—C₃H₇—Si(OCH₃)₃, CH₂═C(CH₃)—CO₂—C₃H₇—Si(OCH₃)₃, CH₂═C(CH₃)—CO₂—C₃H₇—Si (OC₂H₅) 3 and CH₂═C(CH₃)—CO₂—C₃H₇—SiCl₃.

Preference is also given to polymers (A) which have groups which lead to crosslinking during and/or after the formation of the intermediate layer (b). Silanes having 3 hydrolysable groups and also one vinylic group are particularly suitable for this purpose, and examples of these silanes have been set out above.

The polar polymers (A) may be present either individually or as a mixture in the adhesion-promoting intermediate layer (b).

The amount of polymer (A) in the adhesion-promoting intermediate layer (b) may be within a wide range. This is particularly dependent on the nature and the polarity of the polymer (B). The proportion is generally in the range from 30 to 95% by weight, preferably from 40 to 90% by weight, and particularly preferably from 50 to 85% by weight, based on the weight of the intermediate layer (b), but no resultant restriction is intended.

Besides the polar polymer (A), the adhesion-promoting intermediate layer (b) encompasses at least one polymer (B) which has non-polar properties. This property is reflected in the contact angle formed by water on a surface composed of polymers (B). This layer may comprise negligibly small amounts of additives or solvent residues, but it is essential that these additives do not affect the contact angle. The solubility of polymer (B) in water is very small. It is generally smaller than 1 g/l.

The nature of the polymer (B) is subject to no particular restriction, as long as the high level of hydrophobic properties is present, [lacuna] by way of the contact angle formed by water on a surface composed of polymer (B). A polymeric compound suitable as polymer (B) therefore has a high proportion of non-polar groups.

The hydrophobic properties of the polymers (B) are apparent by way of a large contact angle formed by water on a layer of the polymer (B). The contact angle found for a layer of the polymer (B) is therefore greater than or equal to 75°, and the contact angle of the polymers (B) is preferably in the range from 75° to 90° and particularly preferably in the range from 76° to 80°.

The polymer (B) may therefore be obtained by poly-addition or polycondensation reactions. Examples of these are polyethers, polyesters, polycarbonates, polyurethanes and polyamides.

Another group of compounds suitable as polymer (B) is that of polyvinyl compounds. Examples of these are polyolefins, such as polypropylene, polyethylene; polyaryl compounds, such as polystyrene; poly(meth)acrylates and polyvinyl acetates. Vinyl compounds suitable for preparing these polymers have been set out above.

To some extent, the abovementioned polymers encompass polar groups. This is non-critical, as long as the result of their polarity is not that the contact angle formed by water with a layer composed of polymer (B) lies outside the range given. It should be stated here that the polarity of these polymers can be reduced by hydrophobic side chains, such as alkyl chains, in such a way that the abovementioned contact angle values are achieved.

Preferred polymers (B) may be obtained by free-radical polymerization of mixtures which comprise the following constituents

| | | |
|---|---|---|
| (meth)acrylate | 50-100% | by weight |
| methyl (meth)acrylate | 0-60% | by weight |
| preferably | 0-50% | by weight |
| ethyl (meth)acrylate | 0-60% | by weight |
| preferably | 0-50% | by weight |
| C₃-C₆ (meth)acrylate | 0-100% | by weight |
| ≧C₇ (meth)acrylate | 0-50% | by weight |
| polyfunctional (meth)acrylates | 0-5% | by weight |
| comonomers | 0-50% | by weight |
| vinylaromatics | 0-30% | by weight |
| vinyl esters | 0-30% | by weight |

based on the weight of the vinyl compounds.

The non-polar polymers (B) may be present individually or as a mixture in the adhesion-promoting intermediate layer (b).

The amount of polymer (B) present in the adhesion-promoting intermediate layer (b) may be within a wide range. This depends particularly on the nature and the polarity of the polymer (B). The proportion is generally in the range from 5 to 70% by weight, preferably from 10 to 60% by weight and particularly preferably from 15 to 50% by weight, based on the weight of the intermediate layer (b), with no intended resultant restriction.

The intermediate layer (b) may moreover comprise conventional additives. Particular examples of these are surfactants and flow control agents.

An example of a method for producing the intermediate layer (b) uses mixing of polymer (A) and polymer (B) in a suitable solvent or dispersion medium to produce a coating mixture which may comprise the additives set out above. The use of solvent mixtures may be necessary, since the polymers (A) and (B) have differing polarity.

The coating mixtures set out above may be applied to the plastics substrates by any known method. Examples of these are immersion methods, spraying methods, doctoring, flow-coating methods, and application by rollers or by rolls.

The coatings thus applied can generally be hardened or dried in a relatively short time, for example within from 1 minute to 1 hour, generally within from about 3 minutes to 30 minutes, preferably within from about minutes to 20 minutes, and at comparatively low temperatures, for example at from 70 to 110° C., preferably at about 80° C.

The thickness of the intermediate layer is not particularly critical. However, this is selected to be relatively low if possible, for reasons of cost-effectiveness, the lower limit being given by the stability of the entire coating (a) and (b). However, without any intended resultant restriction, the thickness of the adhesion-promoting intermediate layer after hardening is generally in the range from 0.05 μm to 10 μm, preferably from 0.1 μm to 2 μm, and particularly preferably from 0.2 μm to 1 μm. The layer thicknesses of the coatings (a) and/or (b) is determinable by way of a transmission electron micrograph (TEM).

In one particular aspect of the present invention, the contact angle formed by water on an intermediate layer (b) at 20° C. is in the range from 63° to 80°, in particular in the range from 65° to 78° and particularly preferably in the range from 68° to 77°, with no resultant intended restriction.

After the drying of the adhesion-promoting intermediate layer (b), an inorganic coating (a) which inhibits water droplet formation is applied thereto.

The expression “which inhibits water droplet formation” means that a water droplet forms a contact angle of at most 20°, preferably at most 10°, on the surface. This variable is determined at 20° C., using a G40 contact angle measurement system from the company Krüss, Hamburg.

For the purposes of the present invention, the term inorganic means that the carbon content of the inorganic coating is not more than 25% by weight, preferably not more than 17% by weight, and very particularly preferably not more than 10% by weight, based on the weight of the inorganic coating (a). This variable may be determined by elemental analysis.

Particular inorganic coatings which may be applied are polysiloxanes, silane cocondensates and silica sols, the carbon content of these being restricted to the ranges set out above.

Silane cocondensates which may serve for production of the coating (a) are known per se and are used as additives to polymeric glazing materials. Their inorganic character gives them good resistance to UV radiation and weathering effects.

These silane cocondensates may be obtained, inter alia, via condensation or hydrolysis of organosilicon compounds of the general formula (I)
R¹ₙSiX₄₋ₙ (I)
where R¹ is a group having from 1 to 20 carbon atoms, X is an alkoxy radical having from 1 to 20 carbon atoms, or a halogen, and n is an integer from 0 to 3, preferably 0 or 1, and where the various radicals X or R¹ may in each case be identical or different.

The expression “a group having from 1 to 20 carbon atoms” characterizes radicals of organic compounds having from 1 to 20 carbon atoms. It encompasses alkyl groups, cycloalkyl groups, aromatic groups, alkenyl groups and alkynyl groups having from 1 to 20 carbon atoms, and also heteroaliphatic and heteroaromatic groups which have in particular oxygen atoms, nitrogen atoms, sulphur atoms and phosphorus atoms, besides carbon atoms and hydrogen atoms. The groups mentioned may be branched or unbranched, and the radical R¹ here may be substituted or unsubstituted. Among the substituents are in particular halogens, groups having from 1 to 20 carbon atoms, nitro groups, sulphonic acid groups, alkoxy groups, cycloalkoxy groups, alkanoyl groups, alkoxycarbonyl groups, sulphonic ester groups, sulphinic acid groups, sulphinic ester groups, thiol groups, cyanide groups, epoxy groups, (meth)acryloyl groups, amino groups and hydroxy groups. For the purposes of the present invention, the term “halogen” means a fluorine atom, chlorine atom, bromine atom or iodine atom.

Among the preferred alkyl groups are the methyl, ethyl, propyl, isopropyl, 1-butyl, 2-butyl, 2-methylpropyl, tert-butyl, pentyl group, and the 2-methylbutyl group.

Examples of preferred cycloalkyl groups are the cyclopropyl, cyclobutyl, cyclopentyl, cyclohexyl and cycloheptyl group, and the cyclooctyl group, these having substitution, where appropriate, by branched or unbranched alkyl groups.

Examples of preferred alkoxy groups are the methoxy, ethoxy, propoxy, butoxy, tert-butoxy, hexyloxy, 2-methylhexyloxy and decyloxy group, or dodecyloxy group.

Examples of preferred cycloalkoxy groups are cycloalkoxy groups whose hydrocarbon radical is one of the abovementioned preferred cycloalkyl groups.

The radical R¹ is very particularly preferably a methyl or ethyl group.

With respect to the definition of the group X in formula (I) in relation to the alkoxy group having from 1 to 20 carbon atoms, and the halogen, reference may be made to the abovementioned definition. The group X is preferably a methoxy or ethoxy radical or a bromine or chlorine atom.

These compounds may be used individually or as a mixture to prepare silane cocondensates.

Based on the weight of the condensable silanes, it is preferable for at least 80% by weight, in particular at least 90% by weight, of the silane compounds used to have four alkoxy groups or halogen atoms.

Tetraalkoxysilanes encompass tetramethoxysilane, tetraethoxysilane, tetra-n-propoxysilane, tetraiso-propoxysilane and tetra-n-butoxysilanes.

Particular preference is given to tetramethoxysilane and tetraethoxysilane. In one particular aspect of the present invention, the proportion of these particularly preferred tetraalkoxysilanes is at least 80% by weight, in particular at least 90% by weight, based on the weight of the silane compounds used.

In another aspect of the present invention, use may also be made of silane condensates which comprise colloidally dispersed SiO₂ particles. These solutions may be obtained by the sol-gel process, in particular condensing tetraalkoxysilanes and/or tetrahalosilanes.

Aqueous coating compositions are usually prepared from the abovementioned silane compounds by hydrolysing organosilicon compounds with an amount of water sufficient for the hydrolysis process, i.e. >, 0.5 mol of water per mole of the groups intended for hydrolysis, e.g. alkoxy groups, preferably with acid catalysis. Examples of acids which may be added are inorganic acids, such as hydrochloric acid, sulphuric acid, phosphoric acid, nitric acid, etc., or organic acids, such as carboxylic acids, organic sulphonic acids, etc., or acidic ion exchangers, the pH during the hydrolysis reaction generally being from 2 to 4.5, preferably 3.

Once the reactants have been combined, a rise in temperature is generally observed. In certain instances it can be necessary to introduce external heat in order to start the reaction, for example by heating the mixture to 40-50° C. Care is generally taken to prevent the reaction temperature from exceeding 55° C. The reaction time is generally relatively short, and is usually less than one hour, for example 45 min.

The silane compounds may be condensed to give polymers whose weight-average molar mass M_{w} is generally in the range from 100 to 20 000 g/mol, preferably from 200 to 10 000 g/mol, and particularly preferably from 500 to 1500 g/mol. An example of a method for determining this molar mass is NMR spectroscopy.

Examples of ways of terminating the condensation reaction are cooling to temperatures below 0° C., or increasing the pH, using suitable bases, such as organic bases, e.g. amines, alkali metal hydroxides or alkaline earth metal hydroxides.

For further operations, some of the water/alcohol mixture and of the volatile acids may be removed from the reaction mixture, for example by distillation.

The silane cocondensates which can be used according to the invention may comprise curing catalysts, for example in the form of zinc compounds and/or of other metal compounds, e.g. cobalt compounds, copper compounds or calcium compounds, and in particular their octoates or naphthenates. Without any intended resultant restriction, the content of the curing catalysts is generally from 0.1 to 2.5% by weight, specifically from 0.2 to 2% by weight, based on the entire silane cocondensate. By way of example, mention may be made in particular of zinc naphthenate, zinc octoate, zinc acetate, zinc sulphate, etc.

Use may also be made of oxide layers, in particular semimetal and metal oxides, as coating (a) which inhibits water droplet formation. Among suitable compounds are in particular oxides and hydroxides which derive from silicon, from aluminium, from titanium, from zirconium, from zinc and/or from chromium.

These oxides may be used individually or as mixtures, for example in the form of mixed oxides. These oxides and/or hydroxides should have minimum solubility in water, and the solubility in water at 200 should, for example, be below 1000 μg/l, preferably below 200 μg/l.

These oxides may, for example, be applied in the form of colloidal solutions obtained by hydrolysis of alkoxy compounds. These colloidal solutions are disclosed by way of example in EP-A-0 149 182, EP-A-0 826 663, EP-A-0 850 203 and EP-1 022 318.

The particle size of these oxide particles is not critical, but transparency is dependent on the particle size. The size of the particles is preferably at most 300 nm, in particular in a range from 1 to 200 nm, preferably from 1 to 50 nm.

The coating compositions described above may be obtained commercially with the trade name ®Ludox (from the company Grace, Worms); ®Levasil (from the company Bayer, Leverkusen); ®Klebosol (from the company Clariant).

The coating compositions for producing the inorganic coating (a) may moreover comprise conventional additives and processing aids. Examples of these are in particular surfactants and flow control agents.

The coating compositions described above for producing the inorganic coating (a) may be applied using any known method to the plastics substrates, and examples of these have been set out above.

The surface finishes thus applied can generally be fully hardened to give coatings with excellent adhesion in a relatively short time, for example within from 0.5 minute to 1 hour, generally within from about 1 minute to 30 minutes, preferably within from 3 minutes to 20 minutes, and at a comparatively low temperature, for example from 60 to 110° C., preferably at about 80° C.

The layer thickness of the inorganic coating (a) is relatively non-critical. However, without any intended resultant restrictions, the value of this variable after the hardening process is generally in the range from 0.05 μm to 2 μm, preferably from 0.05 μm to 1 μm, and particularly preferably from 0.05 μm to 0.5 μm. The layer thickness of the coatings (a) and (b) is preferably in the range from 0.1 to 3 μm.

The plastics articles of the present invention can be thermoformed with excellent results, without any resultant adverse effect on their coating that inhibits water droplet formation. The forming process is known to the skilled worker. In this process, the plastics article is heated and formed by way of a suitable template. The temperature at which the forming process takes place depends on the softening point of the substrate from which the plastics article was produced. These processes are in particular used for the processing of cast transparent sheets.

The plastics articles of the present invention, provided with a coating which inhibits water droplet formation, have high scrub resistance. The scrub resistance to DIN 537.78 is preferably greater than or equal to 3000 cycles, in particular greater than or equal to 5000 cycles, and particularly preferably greater than or equal to 10 000 cycles.

In one particular aspect of the present invention, the plastics article is transparent, the transparency TD65/10 to DIN 5033 being at least 70%, preferably at least 75%.

Without any intended resultant restriction, the plastics article preferably has a modulus of elasticity to ISO 527-2 of at least 1000 MPa, in particular at least 1500 MPa.

The plastics articles of the invention are generally highly resistant to weathering. For example, the weathering resistance to DIN 53387 (Xenotest) is at least 5000 hours.

Without any intended resultant restriction, the yellowness index to DIN 6167 (D65/10) of preferred plastics articles remains smaller than or equal to 8, preferably smaller than or equal to 5, even after prolonged UV irradiation for more than 5000 hours.

The plastics articles of the present invention may be used in the construction sector, for example, in particular for the production of greenhouses or conservatories, or may serve as a noise barrier.

The invention is illustrated in more detail below by way of inventive examples and comparative examples, but there is no intention that the invention be restricted to these inventive examples.

### INVENTIVE EXAMPLE 1

Production of the Adhesion-Promoting Intermediate Layer

A first copolymer composed of 88% of methyl methacrylate and 12% of gamma-methacryloyloxypropyl-trimethoxysilane and a second copolymer composed of 20% of methyl methacrylate and 80% of butyl methacrylate were dissolved in a ratio of 1:1 in butyl acetate, and applied by flow coating in a thin layer to PMMA sheets. After run-off, the coated sheet is dried in an oven at 80° C. for 20 min.

The contact angle of the dried intermediate layer with water was 76.5° at 20° C. In contrast to this, the contact angle of an intermediate layer produced from the first copolymer was about 66° at 20° C., the methoxy groups of the gamma-methacryloyloxypropyltrimethoxy-silane having been hydrolysed to some extent. An intermediate layer composed of the second copolymer had a contact angle of 77.5° at 20°.

Production of the Layer Which Inhibits Water Droplet Formation

25% of an anionic silica sol (solids content 30%), with 0.1% of the potassium salt of the 3-sulphopropyl ester of O-ethyldithiocarbonic acid and 0.4% of an ethoxylated fatty alcohol are made up to 100 parts with deionized water and coated by flow coating in a thin layer onto the sheet provided with the adhesion-promoting layer.

In order to inhibit or suppress foaming in the coating liquid, a commercially available antifoam may be added if required.

The layer thickness of the adhesion-promoting layer and of the active ingredient layer may, if required, be set as desired by way of dilution with deionized water, where appropriate with addition of further surfactant. In particular in the case of relatively long sheets, it is advantageous to increase the dilution in order to ensure that the layer thickness at the lower end does not become too high, and in order to minimize the layer thickness gradient from the top to the bottom. The layer thickness of the extremely thin layers may be determined by means of a thin section in a transmission electron microscope.

After air-drying, the sheet provided with adhesion-promoting layer and with layer which inhibits water droplet formation is dried in a convection oven at 80° C. for 20 min.

The adhesion of the coating was determined by DIN 53778, using an M 105/A wet scrub tester from the company Gardner. A value at 12 000 cycles was determined.

The plastics article was also thermoformed. Thermoforming was achieved by heating the coated sheets in a convection oven to 150-170° C. The selection of the temperature depends on the heat resistance of the substrate. In the case of extruded PMMA, which unlike cast PMMA has plasticizing comonomers, e.g. acrylates, and has a lower molecular weight, even a relatively low temperature is sufficient. In the case of cast PMMA, which has molecular weights from above 1 million to two or more million, and is frequently composed of pure MMA homopolymer with, where appropriate, weak crosslinking, a higher temperature is used. Once the sheets have softened, they are curved over a semicircular mould with a prescribed bending radius, and allowed to cool.

After forming with a bending radius of 47.5 mm, the sheets produced as in Example 1 show no cloudiness or cracks in the coating, and show good inhibition of water droplet formation, with low contact angles.

The assessment of inhibition of water droplet formation by the contoured substrates can only be visual, because the goniometer is not capable of taking measurements from contoured specimens. Inhibition of water droplet formation was assessed here qualitatively as good.

Again, no wet scrub test can be carried out on the contoured specimens, because this test, too, requires flat substrates.

### COMPARATIVE EXAMPLE 1

Example 1 was substantially repeated, but no second copolymer composed of 20% of methyl methacrylate and 80% of butyl methacrylate was present in the adhesion-promoting intermediate layer. The contact angle for the intermediate layer was 66°.

The scrub resistance was likewise 12 000 cycles. On thermoforming, severe cloudiness was apparent, then the visually assessed inhibition of water droplet formation was poor.

### INVENTIVE EXAMPLE 2

Example 1 is repeated, but the copolymer composed of 88% of methyl methacrylate and 12% of gamma-methacryloylpropyltrimethoxysilane and the second copolymer composed of 20% of methyl methacrylate and 80% of butyl methacrylate is dissolved in a ratio of 8:1 in butyl acetate, and applied in a thin layer to PMMA sheets by flow coating. The contact angle for the intermediate layer was 69.5°.

The scrub resistance is 20 000 cycles. After thermo-forming, the sheet is transparent and effectively inhibits water droplet formation.

### COMPARATIVE EXAMPLE 2

Example 1 was substantially repeated, but the adhesion-promoting intermediate layer comprised a second copolymer composed of 19% of methyl methacrylate, 1% of methacrylic acid and 80% of butyl methacrylate. The contact angle for the intermediate layer was 61°. An intermediate layer composed of the second copolymer gave a contact angle of about 55° at 20°.

On thermoforming, severe clouding was apparent, and the visually assessed inhibition of water droplet formation was poor.

1. A plastic article which inhibits water droplet formation comprising a plastic substrate, at least one inorganic coating (a) which inhibits water droplet formation, and an adhesion-promoting intermediate layer (b) located between the plastics substrate and the inorganic coating, wherein the intermediate layer encompasses two polymers (A) and (B), where water forms a contact angle smaller than or equal to 73° on a layer of the polymer (A) at 20° C. and water forms a contact angle greater than or equal to 75° on a layer of the polymer (B) at 20° C.

2. The plastic article according to claim 1, wherein the plastics substrate encompasses cycloolefin copolymers, polyethylene terephthalates, polycarbonates and/or poly(meth)acrylates.

3. The plastic article according to claim 2, wherein the plastics substrate is composed of polymethyl methacrylate.

4. The plastic article according to claim 1, wherein the plastics substrate has an impact strength of at least 10 kJ/m² to ISO 179/1.

5. The plastic article according to claim 1, wherein the plastics substrate has a thickness in the range from 1 mm to 200 mm.

6. The plastic article according to claim 1, wherein the solubility of polymer (A) in water is smaller than 1 g/l.

7. The plastic article according to claim 1, wherein the solubility of polymer (B) in water is smaller than 1 g/l.

8. The plastic article according to claim 1, wherein the thickness of the adhesion-promoting intermediate layer (b) is in the range of 0.05 and 2.0 μm.

9. The plastic article according to claim 1, wherein the proportion of polymer (A) in the adhesion-promoting intermediate layer (b) is in the range from 30 to 95% by weight, based on the weight of the adhesion-promoting intermediate layer (b).

10. The plastic article according to claim 1, wherein the proportion of polymer (B) in the adhesion-promoting intermediate layer (b) is in the range from 5 to 70% by weight, based on the weight of the adhesion-promoting intermediate layer (b).

11. The plastic article according to claim 1, wherein the polymer (A) is a vinyl polymer modified using polar groups.

12. The plastic article according to claim 1, wherein the polymer (B) is an alkyl (meth)acrylate.

13. The plastic article according to claim 1, wherein the polymer (B) are obtained by free-radical polymerization of mixtures which comprise the following constituents

| | | |
|---|---|---|
| (meth)acrylate | 50-100% | by weight |
| methyl (meth)acrylate | 0-60% | by weight |
| ethyl (meth)acrylate | 0-60% | by weight |
| C₃-C₆ (meth)acrylate | 0-100% | by weight |
| ≧C₇ (meth)acrylate | 0-50% | by weight |
| polyfunctional (meth)acrylates | 0-5% | by weight |
| comonomers | 0-50% | by weight |
| vinylaromatics | 0-30% | by weight |
| vinyl esters | 0-30% | by weight |

based on the weight of the vinyl compounds.

14. The plastic article according to claim 1, wherein the carbon content of the inorganic coating (a) is at most 17% by weight, based on the weight of the coating (a).

15. The plastic article according to claim 1, wherein the inorganic coating (a) can be obtained by curing colloidal solutions of inorganic and/or organometallic compounds.

16. The plastic article according to claim 1, wherein the inorganic coating (a) is obtainable by condensing a composition which encompasses at least 80% by weight of alkyltrialkoxysilanes and/or tetraalkoxysilanes, based on the content of condensable silanes.

17. The plastic article according to claim 1, wherein the inorganic coating a) encompasses condensable polysiloxanes whose molar mass is in the range from 500 to 1 500 g/mol.

18. The plastic article according to claim 1, wherein the thickness of the coatings (a) and (b) is in the range from 0.1 to 3 μm.

19. The plastic article according to claim 1, wherein the scrub resistance of the plastics article to DIN 53778 is at least 10 000 cycles.

20. The plastic article according to claim 1, wherein the plastics article has a modulus of elasticity to ISO 527-2 of at least 1500 MPa.

21. The plastic article according to claim 1, wherein the plastics article has a weathering resistance to DIN 53 387 of at least 5000 hours.

22. The plastic article according to claim 1, wherein the plastics article has a transparency to DIN 5033 of at least 70%.

23. A process for producing a plastic article which inhibits water droplet formation according to claim 1, comprising coating onto a plastics substrate,
a) an adhesion-promoting coating (b) which is applied and then cured, and encompasses two polymers (A) and (B), where water forms a contact angle smaller than or equal to 73° on a layer of the polymer (A) at 20° C., and water forms a contact angle greater than or equal to 75° on a layer of the polymer (B) at 20° C., and then
b) an inorganic coating (a) which inhibits water droplet formation which is applied and then cured.
